(19) United States
(12) Patent Application Publication
(10) Pub. No.: US 2018/0207508 A1
(43) Pub. Date: Jul. 26, 2018

(54) SCREEN BASEBALL SYSTEM USING CAMERA SENSOR AND METHOD THEREOF

(71) Applicant: Realyagu Zone Co., Ltd., Seoul (KR)

(72) Inventors: Seung Jin Lee, Seoul (KR); Han Jo Kwon, Seoul (KR); Hyoung Gon Kim, Seoul (KR)

(21) Appl. No.: 15/878,903

(22) Filed: Jan. 24, 2018

(30) Foreign Application Priority Data
Jan. 26, 2017 (KR) 10-2017-0012930

(51) Int. Cl. A63B 71/02; A63B 69/00; G06T 1/00; G06T 7/20; A63F 13/812

(52) U.S. Cl. CPC A63B 71/022; A63B 69/0002; A63B 2069/0008; G06T 7/20; A63F 13/812; G06T 1/0007

(57) ABSTRACT

The present invention provides a screen baseball system including a camera module (400) for photographing a struck ball. The camera module (400) includes a pair of cameras (410) including a right camera (411) and a left camera (412), and captures a plurality of images including an image of a struck ball or captures a plurality of images of the struck ball in one image, wherein the longitudinal lengths of the imaging ranges (F_{L} and F_{R}) of the pair of cameras (410) are longer than the transverse lengths thereof and the central axes of the horizontal angles of view of the pair of cameras (41) are angled inward with respect to a parallel line facing the front side. Through this, a locus of a struck ball may be effectively calculated while a dead angle is minimized. Further, the present invention provides a method for simulating screen baseball by using the screen baseball system.

### CROSS-REFERENCE TO RELATED APPLICATIONS

This application claims the benefit of Korean Patent Application No. 10-2017-0012930, filed with the Korean Intellectual Property Office on Jan. 26, 2017, the disclosure of which is incorporated herein by reference in its entirety.

### TECHNICAL FIELD

The present invention relates to a screen baseball system, and more particularly, to a screen baseball system using a camera sensor and a method thereof.

### BACKGROUND ART

Screen baseball refers to a baseball game that is performed similarly to an actual baseball game while the user watches a projected image by using devices, such as a screen on which an image is projected, and a pitching machine.

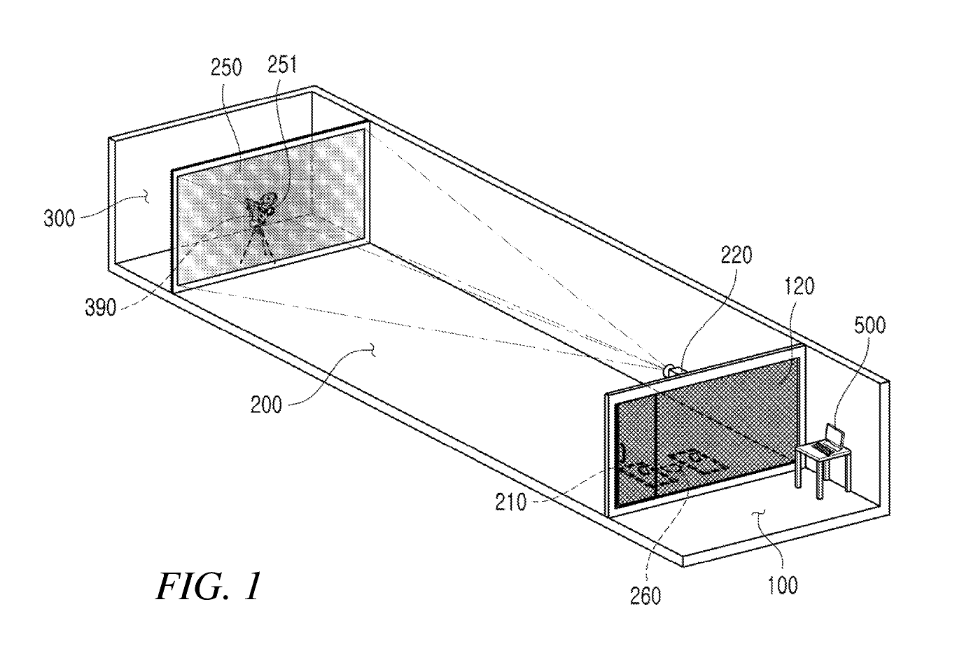

In detail, a screen hole exists at the center of the screen on which an image is projected, and if a ball is discharged through the screen hole from the pitching machine located on an opposite side of the screen, the user strikes the ball toward the screen. Unlike the actual games in which a hit is determined according to an actual progress direction of the struck ball and an action of a defender, the screen baseball system has a spatial restriction and there is no separate defender (see FIG. 1). Accordingly, if various sensors sense a speed and a direction of the struck ball, a locus of the struck ball is automatically calculated by using the sensed result and a baseball game progresses by determining whether the struck ball corresponds to a hit according to the calculated locus.

A laser sensor or a camera sensor is mainly used as a sensor for calculating a speed and a direction of the struck ball.

The laser sensor is a sensor that is installed such that a grating laser beam is generated on a whole spaced section on the front side of a home plate to which the struck ball progresses to sense a speed and a direction of the struck ball at a moment at which the struck ball passes through the grating laser beam. It is determined whether the struck ball corresponds to a hit by calculating the locus of the struck ball by using the sensor.

In this case, it is technically difficult to install the grating laser, and when the ball fails to pass through the grating laser on the front side, as the ball is missed and flies maintaining the direction of its discharge by the pitching machine, or as the speed of the ball is low, as in a bunt, it is impossible to determine whether the struck ball corresponds to a hit, as well as to sense the speed and the direction of the struck ball.

The camera sensor is a sensor that allows a camera to photograph a struck ball at a predetermined time interval to calculate a speed and a direction of the struck ball by using a location deviation and a photographing interval of the balls in repeatedly captured images, or allows a camera to photograph a struck ball by repeated exposure at a predetermined time interval to capture a plurality of struck balls in one image (so-called afterimage photographing) to calculate a speed and a direction of the struck ball by using a location deviation and a flying direction of the ball on the image and the predetermined time interval. It is determined whether the struck ball corresponds to a hit by calculating the locus of the struck ball by using the sensor.

The camera sensor is widely used in screen golf. In screen golf, if a stopped golf ball is struck, it flies only to the front side and it does not fly to a dead angle such as a rear side of the user or an upper side of the head of the user, and accordingly, a photographing range is small because a start point and a flying direction of the struck ball are constant.

However, in contrast, in screen baseball, a ball moves rapidly toward the user and is struck, and the struck ball may fly to the rear side of the back of the user and may fly not to the front side but to the lateral sides when it is missed. Accordingly, based on an installation location or a disposition manner of the camera sensor, it is difficult to calculate a flying locus accurately because a struck ball cannot be identified due to a dead angle caused by the body of the user.

Further, the existing camera sensor only acquires image information obtained by photographing a struck ball a plurality of times. Thereafter, the image information is delivered to a separate image processing unit (generally, a computer) connected to the camera sensor in a wired manner, and the image processing unit calculates a speed and a direction of the struck ball by using the delivered image information and calculates a locus by using the calculated speed and direction. However, an expensive dedicated communication module has to be used to transmit a large amount of image information in a short time due to a limit in communication speed in a process of delivering image information to the image processing unit. When a general communication scheme is used, the size of the image information has to be small, and accordingly, the accuracy of the locus calculated by the image processing unit may become lower.

The related conventional technology will be described.

Korean Patent No. 10-1548511 discloses a screen baseball system that includes a camera sensor and an infrared ray sensor to analyze location information of a struck ball and speed information of the struck ball together to increase the accuracy of a predicted locus.

In this case, a separate matrix sensor is essentially necessary, failure of a camera located directly above the user due to a struck ball is a concern, and there are many points that cannot be measured according to the flying locus of the struck ball due to a dead angle on the rear side of the user.

Korean Patent No. 10-1505931 discloses a screen baseball system in which a network is formed by using infrared rays, and a camera photographs a locus of a struck ball.

Here, a laser sensor and a camera sensor are used together, but there is still a problem when the struck ball does not move to the front side because an infrared ray network functions as a grating laser beam, and the screen baseball system has the disadvantages of the two sensors because the dead angle problem due to the user cannot be solved.

(Patent Document 1) Korean Patent No. 10-1548511B1

(Patent Document 2) Korean Patent No. 10-1505931B1

(Patent Document 2) Korean Patent No. 10-1543371B1

(Patent Document 3) Korean Patent No. 10-1546666B1

(Patent Document 4) Korean Patent No. 10-1572525B1

(Patent Document 5) Korean Patent No. 10-1572526B1

(Patent Document 6) Korean Patent No. 10-1573912B1

### DISCLOSURE

### Technical Problem

The present invention aims to solve the above-mentioned problems.

In detail, the present invention provides a camera sensor of high accuracy that is specialized to a screen baseball system by solving a disadvantage of a laser sensor that requires setting of a grating laser beam and disadvantages of a camera sensor of a dead angle problem, a problem of low calculation accuracy, and a problem of the capacity of transmitted image information.

### Technical Solution

In accordance with an aspect of the present invention, there is provided a screen baseball system including a game zone (200) in which a user is located and an operation zone (300) in which a pitching machine (390) is located, wherein a screen (250) is located between the game zone (200) and the operation zone (300), and the pitching machine (390) discharges a ball toward the game zone (200) through a screen hole (251) located in the screen (250), wherein the screen baseball system further includes a camera module (400) configured to, if the discharged ball is struck, photograph the struck ball, wherein the camera module (400) includes a pair of cameras (410) including a right camera (411) and a left camera (412) to capture a plurality of images including the image of the struck ball or capture a plurality of images of the struck ball in one image, wherein the longitudinal lengths of imaging ranges (F_{R} and F_{L}) of the pair of cameras (410) are longer than the transverse lengths of the imaging ranges (F_{R} and F_{L}) and the central axes of each of the horizontal angles of view of the pair of cameras (410) are angled inward with respect to a parallel line facing the front side.

It is preferable that the imaging range (F_{R}) of the right camera (411) and the imaging range (F_{L}) of the left camera (412) overlap each other. It is preferable that the central axes of the vertical angles of view of both of the pair of cameras (410) are angled towards the front side of a vertical line facing the lower side.

It is preferable that the camera module (400) is located on a rear upper side of a home plate (260) located in the game zone (200) and lower horizontal frames of the imaging ranges (F_{R} and F_{L}) of the pair of cameras (410) are located in the home plate (260).

It is preferable that when a malfunction of any one of the pair of cameras (410) or a shadow zone is recognized, the camera module (400) is operated by a single-eye camera information processing routine in which a locus of the struck ball is calculated by an image captured by the other camera.

It is preferable that the camera module (400) further includes an infrared ray lighting unit (420), and an infrared ray irradiation range (L) of the infrared ray lighting unit (420) is set to be larger than the imaging ranges (F_{R} and F_{L}) of the pair of cameras (410).

It is preferable that the infrared ray lighting unit (420) is located between the right camera (411) and the left camera (412) and is integrally formed with the pair of cameras (410).

It is preferable that the camera module (400) includes an upper surface facing a ceiling, a front surface facing the front side, a low surface facing the bottom, and an inclined surface located between the front surface and the lower surface and facing the front side and the lower side, the upper surface of the camera module (400) is coupled to a ceiling of the game zone (200), and the pair of cameras (410) are located on the inclined surface.

It is preferable that the infrared ray lighting unit (420) is located over the front surface, the lower surface, and the inclined surface.

It is preferable that a standby zone (100) is located on one side of the game zone (200) and a safety net (120) is located between the game zone (200) and the standby zone (100) such that the standby zone (100) and the game zone (200) are distinguished by the safety net (120), the pair of cameras (410) are located in the game zone (200) and the infrared ray lighting unit (420) is located in the standby zone (100), and the infrared ray lighting unit (420) is disposed to face the front side and the bottom.

It is preferable that the infrared ray lighting unit (420) further includes a central lighting part configured to irradiate with infrared rays along a central parallel line facing the front side, and a left lighting part and a right lighting part configured to irradiate with infrared rays such that the infrared rays are angled inward toward the central parallel line.

It is preferable that the camera module (400) senses whether a user is located in a batter box and senses whether a batting operation of the user in the batter box corresponds to a preset operation.

It is preferable that the camera module (400) performs a control such that when it is sensed that a user is not located in the batter box, the pitching machine (390) is not operated, when it is sensed that a user is located in the batter box and a batting operation of the user in the batter box does not correspond to a preset operation, the pitching machine (390) is not operated, and when it is sensed that a user is located in the batter box and a batting operation of the user in the batter box corresponds to a preset operation, the pitching machine (390) is operated after passage of a predetermined standby time.

It is preferable that the camera module (400) senses whether the discharged ball passes through a predetermined strike zone to determine a strike or a ball.

It is preferable that the predetermined strike zone is set in 2-dimensional coordinates in an upper space with respect to one point of the home plate (260), and when the discharged ball is sensed as passing through the coordinates inside the predetermined strike zone, it is determined that the discharged ball is a strike.

It is preferable that the camera module (400) senses the height of the user, and a transverse width of the predetermined strike zone is set to a specific value in an upper space with respect to one point of the home plate (260) and a height of the predetermined strike zone is set to correspond to the height of the sensed user such that the predetermined strike zone is set in 2-dimensional coordinates, and when it is sensed that the discharged ball has passed through a coordinate inside the predetermined strike zone, it is determined that the discharged ball is a strike.

It is preferable that the pair of cameras (410) are provided with fish-eye lenses.

In accordance with another aspect of the present invention, there is provided a method for simulating screen baseball, the method including discharging a ball by the pitching machine (390) such that the discharged ball passes through the screen hole (251), striking the discharged ball such that the struck ball flies, capturing a plurality of images including an image of the struck ball at a predetermined time interval by the pair of cameras (410) of the camera module (400) or capturing a plurality of images of the struck ball in one image by repeated exposure at a predetermined time interval, acquiring the captured image by an information acquisition module (450) of the camera module (400), calculating a speed and a direction of the struck ball by using a plurality of locations of the struck ball in the captured image and a predetermined time and calculating a locus of the struck ball by using the calculated speed and direction, and transmitting the calculated locus to a control unit (500) by a signal transmission module (470) of the camera module (400) and calculating a striking result by using the transmitted locus by the control unit (500).

### Advantageous Effects

The following effects may be achieved by the present invention.

First, the camera may sense the speed and direction of a struck ball by accurately detecting the struck ball.

To achieve this, the present invention adjusts an irradiation direction of infrared rays to a photographing direction of the camera, sets the irradiation area of the infrared rays to be wider than the imaging range, and allows the imaging range to pass through the home plate and makes a transverse length of the imaging range longer than a longitudinal length of the imaging range. Further, after the camera module directly acquires and processes an image and calculates a locus of the struck ball, it transmits the calculated locus to the control unit to solve a problem of delivering image information of a high capacity.

Second, a dead angle of the camera sensor is minimized.

To achieve this, the present invention employs a pair of cameras, disposes the cameras such that the photographing ranges of the left camera and the right camera cross each other when viewed from a horizontal direction, and locates the cameras such that the cameras obliquely look down from a side that is slightly back from the home plate.

Third, the stability of the camera module is increased.

To achieve this, the camera module is installed on a ceiling on a side that is slightly back from the home plate and to which the struck ball flies the least. In some embodiments, the infrared ray lighting unit may be located in a standby area outside a safety net.

### DESCRIPTION OF THE INVENTION

FIG. 1 is a schematic diagram of a screen baseball system according to the present invention.

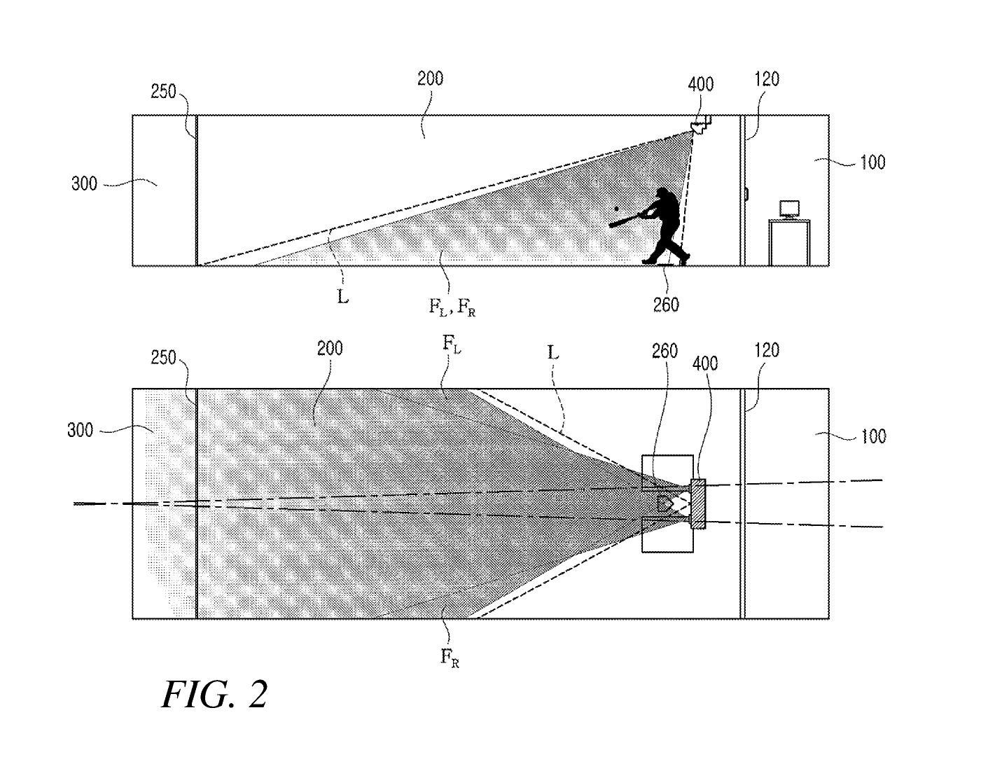

FIG. 2 illustrates a side sectional view and a plan view of the screen baseball system according to a first embodiment of the present invention.

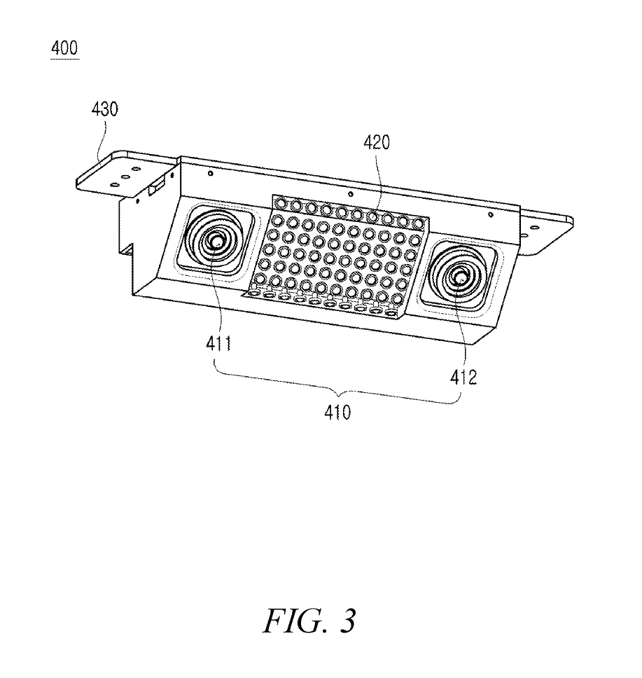

FIG. 3 is a perspective view of a camera module of the screen baseball system according to the first embodiment of the present invention.

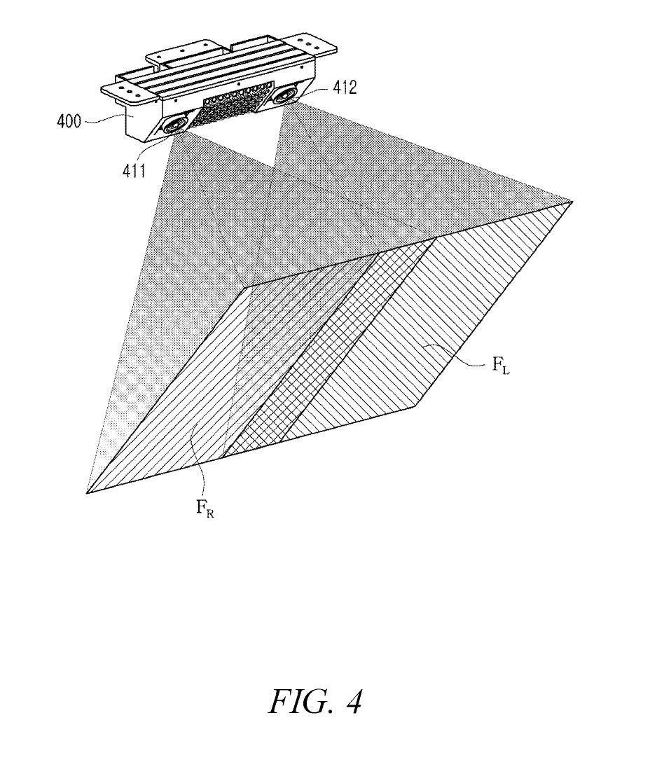

FIG. 4 is a view for explaining imaging ranges F_{R} and F_{L} in the camera module of the screen baseball system according to the first embodiment of the present invention.

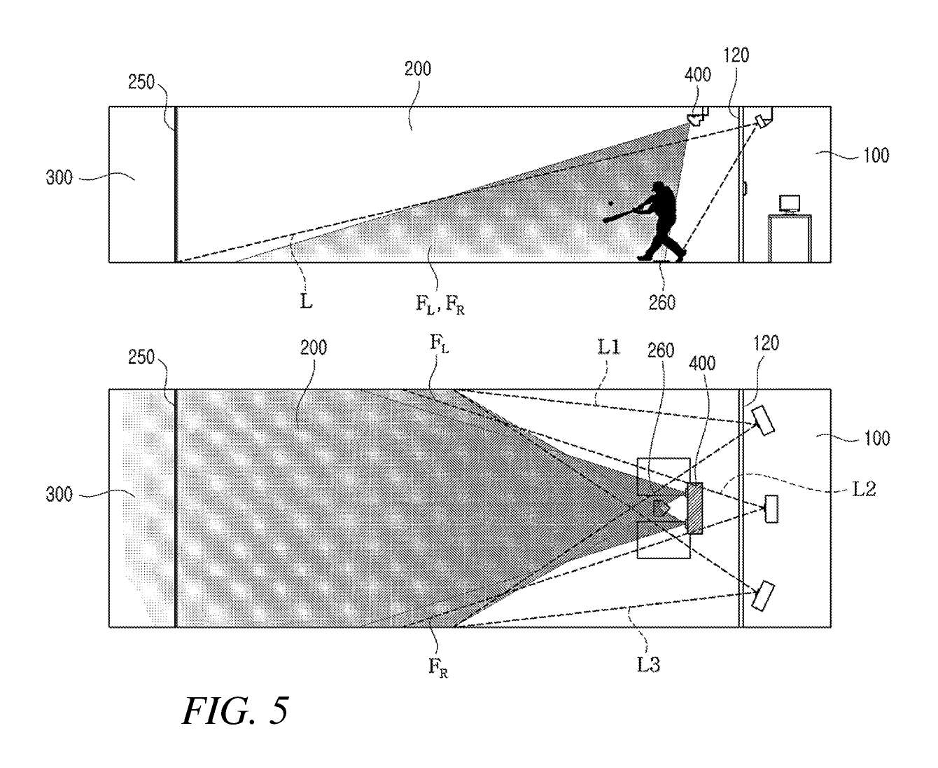

FIG. 5 illustrates a side sectional view and a plan view of a screen baseball system according to a second embodiment of the present invention.

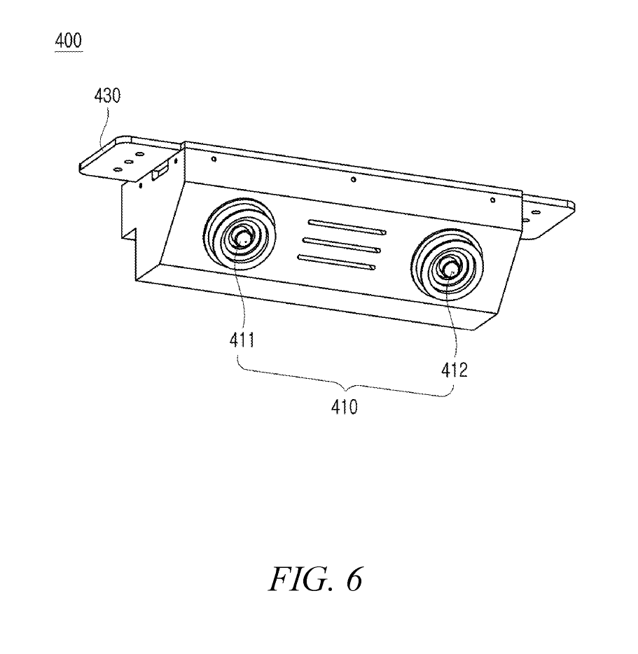

FIG. 6 is a perspective view of a camera module of the screen baseball system according to the second embodiment of the present invention.

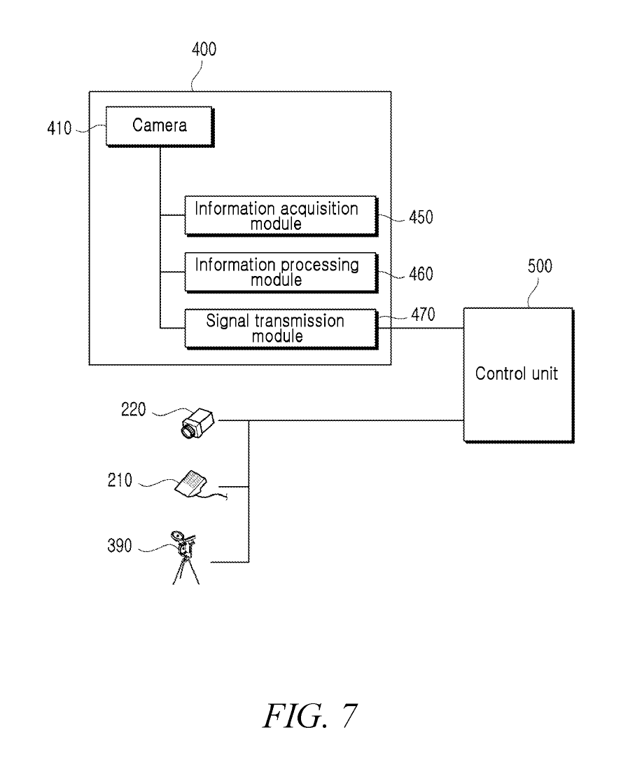

FIG. 7 is a schematic diagram for explaining a method for controlling a screen baseball system according to the present invention.

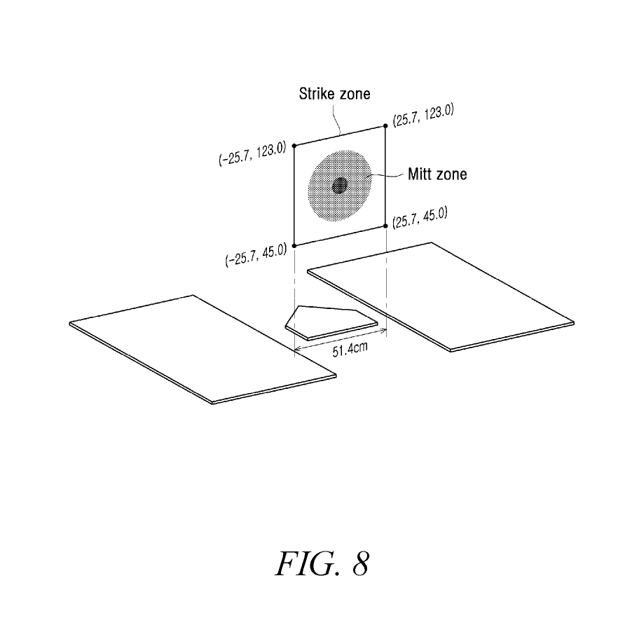

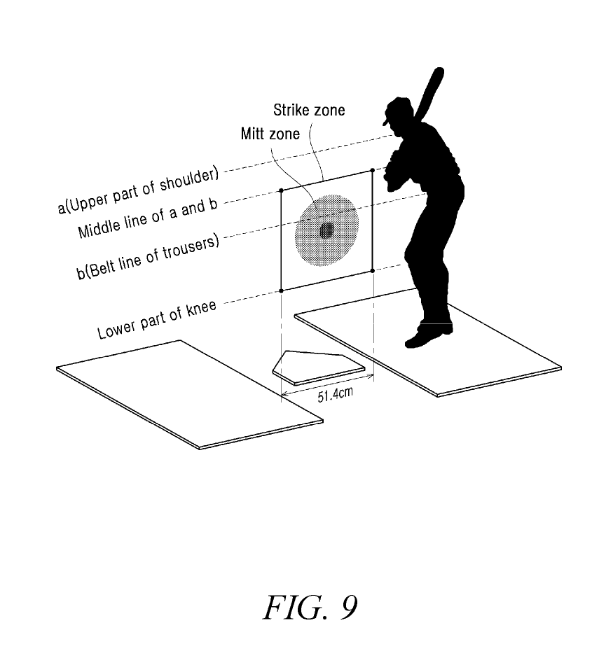

FIGS. 8 and 9 are schematic views for explaining a method for identifying whether a ball is a strike in the screen baseball system according to the present invention.

### BEST MODE

Hereinafter, “a striking result” refers to a result obtained after a batter that is a user of an offensive team strikes a ball discharged form a pitching machine. A speed and a direction of the struck ball are identified by sensors, and the striking result is the result obtained by using the speed and the direction of the struck ball. That is, the striking result may be an “out” or a “hit”. The “hit” may be variously calculated, for example, to a short-distance hit, a long-distance hit, or a homerun.

Hereinafter, “a front side” refers to a direction in which the user in a game zone 200 faces a screen 250, and “a rear side” refers to an opposite direction. That is, a direction in which a ball flies after a batter that is a user normally strikes a ball is the front side. For example, in FIGS. 2, 3, 5, and 6, the left side is the front side, and the right side is the rear side.

Hereinafter, the present invention will be described in more detail with reference to the accompanying drawings.

Referring to FIG. 1, a screen baseball system according to the present invention will be described.

The interior space of a playing field is classified into a standby zone 100, a game zone 200, and an operation zone 300.

The standby zone 100 is a zone that is distinguished and protected from the game zone 200 by a safety net 120 and the like.

A pedal 210, an image unit 220, a screen 250, and the like are located in the game zone 200.

The pedal 210 is a configuration for applying a baseball discharge signal to a control unit 500 by the user. If the user depresses the pedal 210, a baseball is discharged from a pitching machine 390.

The image unit 220 receives image information from the control unit 500 and projects an image to the screen 250.

A screen hole 251 is located at the center of the screen 250. In a striking mode, a baseball discharged from the pitching machine 390 passes through the screen hole 251 and flies toward the user in the game zone 200, and a game is performed by the user striking the baseball.

In the game zone 200, a home plate 260 and left and right batter boxes are drawn on the bottom near the safety net 120. The user is located in any one of the left and right batter boxes to strike a ball that flies toward the home plate 260.

The operation zone 300 is distinguished from the game zone 200 by the screen 250 such that the user cannot enter the operation zone 300. The pitching machine 390 is located in the operation zone 300 to discharge a baseball.

Meanwhile, a camera module 400 coupled to the ceiling is located on the upper rear side of the home plate 260 in the game zone 200.

The camera module 400 includes a pair of cameras 410 including a right camera 411 and a left camera 412, an infrared ray lighting unit 420, a support plate 430, an information acquisition module 450, an information processing module 460, and a signal transmission module 470.

Here, in the first embodiment, the infrared ray lighting unit 420 is integrally formed with the camera module 400 inside the camera module 400, and in the second embodiment, the infrared ray lighting unit 420 is provided separately from the pair of cameras 410, and this will be described below.

Referring to FIGS. 2 to 4 and 7, the first embodiment of the present invention will be described.

In the first embodiment, as illustrated in FIG. 3, the camera module 400 includes a pair of cameras 410, and an infrared ray lighting unit 420 integrally located between the pair of cameras 410.

A housing of the camera module 400, which is exposed to the outside, includes an upper surface facing the ceiling, a front surface facing the front side, a lower surface facing the bottom, and an inclined surface located between the front surface and the lower surface and facing the front side and the bottom.

The support plate 430 is located on the upper surface of the camera module 400, and the camera module 400 is installed on the ceiling of the game zone 200 by using the support plate 430.

The pair of cameras 410 are located on the inclined surface of the camera module 400. Accordingly, the pair of cameras 410 naturally face the front lower side.

An installation location of the camera module 400 will be described in detail.

The camera module 400 is installed on an upper ceiling on the rear side of the home plate 260. Accordingly, the central axes of the vertical angles of view of both the pair of cameras 410 may be angled to face the front side of the vertical line facing the lower side (see the upper drawing of FIG. 2). In detail, the lower horizontal frames of the imaging ranges F_{R} and F_{L} are located in the home plate 260. In an embodiment, it is preferable that the camera module 400 be located on the ceiling on a rear side that is distant from the center of the home plate 260 by about 70 cm.

Further, the right camera 411 and the left camera 412, which are the pair of cameras 410 of the camera module 400, are installed such that their directions converge. That is, the imaging range F_{R} of the right camera 411 and the imaging range F_{L} of the left camera 412 overlap each other. In other words, the central axes of each of the horizontal angles of view of the pair of cameras 410 are angled to the inner side of the horizontal line facing the front side (the alternately long- and short-dashed line of the lower drawing of FIG. 2).

Further, the longitudinal lengths of the imaging ranges F_{R} and F_{L} of the pair of cameras 410 are longer than the transverse lengths of the imaging ranges F_{R} and F_{L}. Although the transverse lengths of the imaging ranges F_{R} and F_{L} of a general camera are longer than the longitudinal lengths of the imaging ranges F_{R} and F_{L} (for example, 4:3), the longitudinal lengths of the imaging ranges F_{R} and F_{L} of the cameras according to the present invention are longer than the transverse lengths of the imaging ranges F_{R} and F_{L}, as illustrated in FIG. 4 (for example, 3:4). This is caused by the distinctiveness of the playing field of the screen baseball system, because as illustrated in FIG. 1, the length of the playing field is longer than the width of the playing field, and the struck ball generally travels in the lengthwise direction.

Meanwhile, another embodiment may further include a fish-eye lens (not illustrated), an angle of view of which reaches 180 degrees such that the image range and the angle of view become wider. Through this, the dead angle may be minimized. In this case, a separate unit for correcting distortion due to the fish-eye lens is necessary.

The infrared ray lighting unit 420 is located at the front surface, the inclined surface, and the lower surface of the camera module 400. Through this, the infrared ray irradiation range L of the infrared ray lighting unit 420 may be set to be larger than the imaging ranges F_{R} and F_{L} of the pair of cameras 410.

Here, the lighting direction of the infrared ray lighting unit 420 is important. This is because an area that receives infrared ray lighting from the struck ball is sensed by the camera module 400.

The most ideal lighting direction is the same as the photographing direction of the camera. Accordingly, as in the first embodiment, the configuration in which the infrared ray lighting unit 420 is located between the pair of cameras 410 is a configuration of providing ideal lighting to the struck ball.

In a summary of the disposition manner of the camera module 400, the pair of cameras 410 look down at the home plate 260 obliquely on the rear side of the home plate 260, and the directions of the right camera 411 and the left camera 412 are not parallel and converge to each other.

The above-described disposition method has two effects.

First, the speed and the direction of the struck ball may be effectively detected while the location of the dead angle is minimized, by reflecting the characteristics of the screen baseball system.

The present invention uses the fact that it is normal to strike the ball discharged from the pitching machine 390 mainly in the space directly above the home plate 260. Although the user may be located at the front location or the rear location of the batter box such that the striking location is on the front or rear side of the home plate 260, the ball is typically struck above the home plate 260.

The speed and the direction of the struck ball are determined immediately after the striking. That is, when an image of the struck ball is acquired at the moment of the striking and immediately after the ball is struck above the home plate 260, a locus of the ball may be calculated based on the acquired image.

Accordingly, it is natural that the home plate 260 be included in the imaging ranges F_{R} and F_{L} of the pair of cameras 410.

Meanwhile, the present invention sets a disposition method for reducing the dead angle of the camera sensor based on the above-mentioned fact, unlike the conventional technology, while the home plate 260 is included in the imaging ranges F_{R} and F_{L}.

The case in which the dead angle of the camera sensor is generated in the screen baseball game corresponds to a case in which the ball that is struck above the home plate 260 flies toward the batter and disappears at the rear side of the back of the batter and a case in which the struck ball flies rearwards, that is, the ball maintains the direction in which the ball is discharged from the pitching machine 390.

In order to prevent the former case, the right camera 411 and the left camera 412 are installed such that the directions of the right camera 411 and the left camera 412 converge. As compared with the case in which the cameras are installed such that the directions thereof are parallel to each other or are scattered, a larger portion of the back side of the batter may be included in the imaging ranges F_{R} and F_{L}.

For example, even when the struck ball flies to the rear side of the back of the user located on the right-handed batter box (the left batter box), the right camera 411 may photograph the ball from the moment when the ball starts to fly above the home plate 260 before the ball completely disappears to the rear side of the back of the batter such that an area that cannot be photographed due to the dead angle may be minimized.

In order to prevent the latter case, the camera module 400 is installed directly on the rear side of the home plate 260. Through this, even when the ball is missed after being struck above the home plate and travels straight without its direction changing, the direction of the ball is included in the imaging ranges F_{R} and F_{L} of the camera 410.

That is, as compared with the conventional technology in which the camera is installed on an upper ceiling of the home plate 260 such that only the home plate is included in the imaging range, the accuracy of measuring the speed and the direction of the struck ball may be increased, and the dead angle may be minimized as well by obliquely installing the right camera 411 and the left camera 412 on the rear side and installing the right camera 411 and the left camera 412 such that the directions thereof cross each other.

Second, the stability of the camera module 400 may be improved.

When the camera module is located on the upper ceiling of the home plate 260 as in the conventional technology, the struck ball may strike the camera module, thereby damaging the camera module. Accordingly, as the camera module is located further to the rear side, the possibility of striking the camera module by the ball becomes lower.

Meanwhile, as illustrated in FIG. 7, an information acquisition module 450, an information processing module 460, and a signal transmission module 470 may be embedded in the camera module 400 according to the present invention.

If the pair of cameras 410 acquires a plurality of images including the struck ball by repeatedly photographing the struck ball at a predetermined time interval, or captures a plurality of images of the struck ball in one image by repeated exposure at a predetermined time interval, the information acquisition module 450 acquires the captured image, and the information processing module 460 calculates the speed and the direction of the struck ball by using the plurality of locations of the struck ball and the predetermined time interval in the captured image, calculates the locus of the struck ball by using the calculated speed and direction, and transmits only the resulting calculated locus to the separate control unit 500.

Then, the information acquisition module 450 may allow the user to identify the image information by using only the camera module 400 as the acquired image information is reproduced. Of course, the image information may be transmitted to a separate image processing unit.

Although a problem due to a limitation of the cable may occur because of the capacity of the transmitted image information because the entire captured image has to be delivered to the control unit in the conventional technology, the capacity of the transmitted information is low because only the calculated locus is transmitted such that information may be effectively delivered and processed according to the present invention.

Meanwhile, it is preferable that the camera module 400 according to the present invention may be operated by a single-eye camera information processing routine. In detail, it is preferable that when a malfunction of any one of the pair of cameras 410 or a shadow zone is recognized, the camera module 400 is operated by a single-eye camera information processing routine in which a locus of the struck ball is calculated by an image captured by the other camera.

Further, the camera module 400 according to the present invention may automate an operation of the pitching machine 390 by sensing whether the user is located in the batter box as well as sensing the struck ball, and may determine whether the discharged ball is a strike by additionally sensing whether the ball discharged from the pitching machine 390 passes through the strike zone.

First, a method for identifying whether the user is located in the batter box will be described. To achieve this, it is preferable that the camera module 400 sense whether a batting operation of the user in the batter box corresponds to a preset operation. As illustrated in the drawings, this is because the batter box is included in the imaging ranges F_{R} and F_{L} of the camera module 400.

Here, the preset operation may be any one of an operation of slightly rotating the end of the bat by the user, an operation of raising the bat by the user, and the like, and the manufacturer may set the preset operation. That is, in a process utilizing the camera module 400, because an operation of the pitching machine 390 may be controlled as a signal is transmitted to the pitching machine 390 when the user undertakes a preset operation instead of control of an operation of the pitching machine 390 by the separate pedal 210, the game may be managed more conveniently.

Through the sensing, an operation of the pitching machine 390 may be derived and safety may be reinforced by toggling an operation of the pitching machine 390.

For example, when the camera module 400 senses that the user is not located in the batter box, the pitching machine 390 is controlled not to be operated.

Further, when the camera module 400 senses that the user is located in the batter box and a batting operation of the user in the batter box does not correspond to a preset operation, the pitching machine 390 is not operated.

Through this, because the pitching machine 390 may be prevented from being abruptly operated to discharge a ball while there is no user or the user is located in the batter box but is not ready to strike a ball, safety is reinforced.

When the camera module 400 senses that a user is located in the batter box and a batting operation of the user in the batter box corresponds to a preset operation, the pitching machine 390 is operated after passage of a predetermined standby time. The predetermined standby time may be about 5 seconds.

Through this, if the user enters the batter box and informs the pitching machine 390 that he or she is ready by raising the bat or slightly shaking the bat or the like, the pitching machine 390 then discharges a ball, thereby reinforcing safety and enhancing convenience of the user as well.

Next, a method for sensing whether a discharged ball passes through a strike zone and identifying whether the discharged ball is a strike by the camera module 400 will be described.

The strike zone is a virtual area set by 2-dimensional coordinates, and is set to an upper side of the home plate 260. If it is sensed that the discharged ball has passed through a coordinate inside the predetermined strike zone, it is determined that the struck ball is a strike.

The strike zone may be set by the following two methods.

The first method is a method of constantly setting a strike zone regardless of the body size of the user (see FIG. 8). A virtual strike zone is set to a transverse width of 51.4 cm and a vertical height of 78 cm on the upper side of the home plate 260. The discharged ball is determined as a strike if it passes through the set strike zone, and is otherwise determined as a ball.

For example, as illustrated in FIG. 8, a virtual strike zone having coordinates of (−25.7, 45.0), (−25.7, 123.0), (25.7, 45.0), and (25.7, 123.0) may be set in advance as a virtual strike zone located at a height of 45 cm with respect to a reference of (0,0) of the front center of the home plate 260, and when it is sensed by the camera module 400 that the coordinate which the discharged ball passes through is (10, 55), the discharged ball may be determined as a strike, and in the case of (30, 100), it may be determined as a ball.

The second method is a method of setting a strike zone according to the body size of the user (see FIG. 9). The camera module 400 may sense the height of the user by using a conventionally known technology, and the height of the strike zone corresponding to the height of the user and the vertical height of the area are stored in a separate database such that the strike zone is automatically set. Here, the transverse width is determined by a specific value of 51.4 cm with respect to one point of the home plate 260 as in the first method.

For example, because the height of the waist is 98 cm, the height of the knee is 44 cm, and the height of the shoulder is 144 cm according to a standard body ratio of a person of a height of 170 cm, a vertical height of 77 cm, starting from a lower part of the knee of 44 cm to an intermediate point of 121 cm between the belt line (the height of the waist) of the trousers and an upper part (the height of the shoulder) of the shoulder, is stored in advance as a strike zone for the user of a height of 170 cm. Accordingly, when the camera module 400 senses that the height of the user is 170 cm, the height and the vertical length of the strike zone are automatically set to 44 cm and 77 cm, respectively.

Meanwhile, as illustrated in FIGS. 8 and 9, a separate mitt zone may be set together with the strike zone. Unlike the fixed strike zone, the mitt zone may be changed according to various conditions. Through this, in a pitching mode game in which the user pitches a ball, probabilities of “a hit” (a long-distance hit or a short-distance hit), “a strike”, and “a ball” may be calculated by combining whether the discharged ball passes through the strike zone and whether the discharged ball passes through the mitt zone, and may be provided to the user.

Referring to FIGS. 5 and 6, the second embodiment of the present invention will be described.

Unlike the first embodiment, in the second embodiment, the infrared ray lighting unit 420 and the camera 410 are not integrally formed but are located separately.

In detail, as illustrated in FIG. 5, the standby zone 100 is located on one side of the game zone 200 and the safety net 120 is located between the game zone 200 and the standby zone 100 such that the game zone 200 and the standby zone 100 are divided by the safety net 120, and the pair of cameras 410 are located in the game zone 200 and the infrared ray lighting unit 420 is located in the standby zone 100. That is, the infrared ray lighting unit 420 is protected from the game zone 200, in which the struck ball flies, by the safety net 120.

In this case, the infrared ray lighting unit 420 is protected from the struck ball with certainty.

However, as described in the first embodiment, this is not the most ideal infrared ray irradiating direction. Accordingly, in the second embodiment, in order to prevent this, the infrared ray lighting unit 420 includes a central lighting part that irradiates with infrared rays along a central parallel line facing the front side, and a left lighting part and a right lighting part that irradiate with infrared rays such that the infrared rays are angled inward toward the central parallel line.

Accordingly, the infrared ray irradiating ranges L1, L2, and L3 may be set to be substantially larger than the imaging ranges F_{R} and F_{L} of the pair of cameras 410.

A method of simulating a screen baseball game by using such a screen baseball system will be described.

If the user is located in the game zone 200 and applies a baseball discharge signal by using a pedal 210 or the like, the pitching machine 390 in the operation zone 300 discharges a ball such that the ball passes through the screen hole 251.

The discharged ball is struck by the user, and the struck ball flies.

The pair of cameras 410 of the camera module 400 acquires a plurality of images including the struck ball by repeatedly photographing the struck ball at a predetermined time interval, or acquires the captured image if a plurality of images of the struck ball is captured in one image through repeated exposure at a predetermined time interval.

The information acquisition module 450 of the camera module 400 acquires the captured image, and the information processing module 460 calculates a speed and a direction of the struck ball by using a location of the struck ball on a plurality of acquired images and a predetermined time, or calculates a speed and a direction of the struck ball by using locations of the plurality of struck balls in the captured image and a predetermined time to calculate a locus of the struck ball by using the calculated speed and direction.

The signal transmission module 470 of the camera module 400 transmits the calculated locus to the control unit 500, and the control unit 500 calculates a striking result by using the transmitted locus.

Although the preferred embodiments of the present invention have been described, it will be understood by those skilled in the art that the present invention can be variously corrected and modified without departing from the spirit and scope of the present invention claimed in the claims. Further, when one or more of the various embodiments are combined, it also pertains to the scope of the present invention.

### DESCRIPTION OF REFERENCE NUMERALS

100: Standby zone

120: Safety net

200: Game zone

210: Pedal

220: Image unit

250: Screen

251: Screen hole

260: Home plate

300: Operation zone

390: Pitching machine

400: Camera module

Camera

411: Right camera

412: Left camera

420: Infrared ray lighting unit

430: Support plate

450: Information acquisition module

460: Information processing module

470: Signal transmission module

500: Control unit

F_{L}: Left imaging range

F_{R}: Right imaging range

L: Infrared ray irradiating range

What is claimed is:

1. A screen baseball system comprising a game zone in which a user is located and an operation zone in which a pitching machine is located,
wherein a screen is located between the game zone and the operation zone, and the pitching machine discharges a ball toward the game zone through a screen hole located in the screen,
wherein the screen baseball system further comprises a camera module configured to, if the discharged ball is struck, photograph the struck ball,
wherein the camera module includes a pair of cameras including a right camera and a left camera to capture a plurality of images including the image of the struck ball or capture a plurality of images of the struck ball in one image,
wherein the longitudinal lengths of imaging ranges (F_{R} and F_{L}) of the pair of cameras is longer than the transverse lengths of the imaging ranges (F_{R} and F_{L}) and the central axes of the horizontal angles of view of the pair of cameras are angled inward with respect to a parallel line facing the front side, and
wherein when a malfunction or a shadow zone of any one of the pair of cameras is recognized, the camera module is operated by a single-eye camera information processing routine in which a locus of the struck ball is calculated by an image captured by the other camera.

2. The screen baseball system of claim 1, wherein the imaging range (F_{R}) of the right camera and the imaging range (F_{L}) of the left camera overlap each other.

3. The screen baseball system of claim 1, wherein the central axes of the vertical angles of view of both of the pair of cameras are angled towards the front side of a vertical line facing the lower side.

4. The screen baseball system of claim 3, wherein the camera module is located on a rear upper side of a home plate located in the game zone and lower horizontal frames of the imaging ranges (F_{R} and F_{L}) of the pair of cameras are located in the home plate.

5. The screen baseball system of claim 1, wherein the camera module further includes an infrared ray lighting unit, and
wherein an infrared ray irradiation range (L) of the infrared ray lighting unit is set to be larger than the imaging ranges (F_{R} and F_{L}) of the pair of cameras.

6. The screen baseball system of claim 6, wherein the infrared ray lighting unit is located between the right camera and the left camera and is integrally formed with the pair of cameras.

7. The screen baseball system of claim 7, wherein the camera module includes:
an upper surface facing a ceiling;
a front surface facing the front side;
a low surface facing the bottom; and
an inclined surface located between the front surface and the lower surface and facing the front side and the lower side,
wherein the upper surface of the camera module is coupled to a ceiling of the game zone, and
wherein the pair of cameras are located on the inclined surface.

8. The screen baseball system of claim 8, wherein the infrared ray lighting unit is located at the front surface, the lower surface, and the inclined surface.

9. The screen baseball system of claim 6, wherein a standby zone is located on one side of the game zone and a safety net is located between the game zone and the standby zone such that the standby zone and the game zone are distinguished by the safety net,
wherein the pair of cameras are located in the game zone and the infrared ray lighting unit is located in the standby zone, and
wherein the infrared ray lighting unit is disposed to face the front side and the bottom.

10. The screen baseball system of claim 10, wherein the infrared ray lighting unit further includes:
a central lighting part configured to irradiate with infrared rays along a central parallel line facing the front side; and
a left lighting part and a right lighting part configured to irradiate with infrared rays such that the infrared rays are angled inward toward the central parallel line.

11. A screen baseball system comprising a game zone in which a user is located and an operation zone in which a pitching machine is located,
wherein a screen is located between the game zone and the operation zone, and the pitching machine discharges a ball toward the game zone through a screen hole located in the screen,
wherein the screen baseball system further comprises a camera module configured to, if the discharged ball is struck, photograph the struck ball,
wherein the camera module includes a pair of cameras including a right camera and a left camera to capture a plurality of images including the image of the struck ball or capture a plurality of images of the struck ball in one image,
wherein the longitudinal lengths of imaging ranges (F_{R} and F_{L}) of the pair of cameras are longer than the transverse lengths of the imaging ranges (F_{R} and F_{L}) and the central axes of the horizontal angles of view of the pair of cameras are angled inward with respect to a parallel line facing the front side,
wherein the camera module senses whether a user is located in a batter box and senses whether a batting operation of the user in the batter box corresponds to a preset operation, and
wherein the camera module performs a control such that:
when it is sensed that a user is not located in the batter box, the pitching machine is not operated;
when it is sensed that a user is located in the batter box and a batting operation of the user in the batter box does not correspond to a preset operation, the pitching machine is not operated; and
when it is sensed that a user is located in the batter box and a batting operation of the user in the batter box corresponds to a preset operation, the pitching machine is operated after passage of a predetermined standby time.

12. A screen baseball system comprising a game zone in which a user is located and an operation zone in which a pitching machine is located,
wherein a screen is located between the game zone and the operation zone, and the pitching machine discharges a ball toward the game zone through a screen hole located in the screen,
wherein the screen baseball system further comprises a camera module configured to, if the discharged ball is struck, photograph the struck ball,
wherein the camera module includes a pair of cameras including a right camera and a left camera to capture a plurality of images including the image of the struck ball or capture a plurality of images of the struck ball in one image,
wherein the longitudinal lengths of imaging ranges (F_{R} and F_{L}) of the pair of cameras are longer than the transverse lengths of the imaging ranges (F_{R} and F_{L}) and the central axes of the horizontal angles of view of the pair of cameras are angled inward with respect to a parallel line facing the front side,
wherein the camera module senses whether the discharged ball passes through a predetermined strike zone to determine a strike or a ball,
wherein the camera module senses the height of the user,
wherein a transverse width of the predetermined strike zone is set to a specific value in an upper space with respect to one point of the home plate and a height of the predetermined strike zone is set to correspond to the height of the sensed user such that the predetermined strike zone is set in 2-dimensional coordinates, and
wherein, when it is sensed that the discharged ball has passed through a coordinate inside the predetermined strike zone, it is determined that the struck ball is a strike.

13. The screen baseball system of claim 1, wherein the pair of cameras are provided with fish-eye lenses.

14. A method for simulating a screen baseball by using the screen baseball system of claim 1, the method comprising:
discharging a ball by the pitching machine such that the discharged ball passes through the screen hole;
striking the discharged ball such that the struck ball flies;
capturing a plurality of images including an image of the struck ball at a predetermined time interval by the pair of cameras of the camera module or capturing a plurality of images of the struck ball in one image by repeated exposure at a predetermined time interval by the pair of cameras of the camera module;
acquiring the captured image by an information acquisition module of the camera module;
calculating a speed and a direction of the struck ball by using a plurality of locations of the struck ball in the captured image and a predetermined time and calculating a locus of the struck ball by using the calculated speed and direction; and
transmitting the calculated locus to a control unit by a signal transmission module of the camera module and calculating a striking result by using the transmitted locus by the control unit.

15. A method for simulating a screen baseball by using the screen baseball system of claim 12, the method comprising:
discharging a ball by the pitching machine such that the discharged ball passes through the screen hole;
striking the discharged ball such that the struck ball flies;
capturing a plurality of images including an image of the struck ball at a predetermined time interval by the pair of cameras of the camera module or capturing a plurality of images of the struck ball in one image by repeated exposure at a predetermined time interval by the pair of cameras of the camera module;
acquiring the captured image by an information acquisition module of the camera module;
calculating a speed and a direction of the struck ball by using a plurality of locations of the struck ball in the captured image and a predetermined time and calculating a locus of the struck ball by using the calculated speed and direction; and
transmitting the calculated locus to a control unit by a signal transmission module of the camera module and calculating a striking result by using the transmitted locus by the control unit.

16. A method for simulating a screen baseball by using the screen baseball system of claim 13, the method comprising:
discharging a ball by the pitching machine such that the discharged ball passes through the screen hole;
striking the discharged ball such that the struck ball flies;
capturing a plurality of images including an image of the struck ball at a predetermined time interval by the pair of cameras of the camera module or capturing a plurality of images of the struck ball in one image by repeated exposure at a predetermined time interval by the pair of cameras of the camera module;
acquiring the captured image by an information acquisition module of the camera module;
calculating a speed and a direction of the struck ball by using a plurality of locations of the struck ball in the captured image and a predetermined time and calculating a locus of the struck ball by using the calculated speed and direction; and
transmitting the calculated locus to a control unit by a signal transmission module of the camera module and calculating a striking result by using the transmitted locus by the control unit.
